(19) United States
(12) Patent Application Publication
(10) Pub. No.: US 2004/0056027 A1
(43) Pub. Date: Mar. 25, 2004

(54) Microkettle

(76) Inventor: Jessica Sita Miller, Las Vegas, NV (US)

Correspondence Address: Jessica Miller, 2500 Karen Avenue #62, Las Vegas, NV, 89121, US

(21) Appl. No.: 10/634,083

(22) Filed: Aug. 2, 2003

Related U.S. Application Data
(60) Provisional application No. 60/403,097, filed on Aug. 12, 2002.

(51) Int. Cl. H05B 6/80

(52) U.S. Cl. 219/725

(57) ABSTRACT

A kettle (10) for heating liquid in a microwave oven to a specific temperature, which is readable on a contained thermometer (20). The kettle (10) also has a removable filter (28) for purifying water and a volume measure (22) for determining how much liquid in inside it.

### CROSS-REFERENCE TO RELATED APPLICATIONS

This application claims the benefit of PPA Ser. No. 60/403,097, filed 2002 Aug. 12 by the present inventor.

### FEDERALLY SPONSORED RESEARCH

Not Applicable

### SEQUENCE LISTING OR PROGRAM

Not Applicable

### BACKGROUND OF THE INVENTION—FIELD OF THE INVENTION

This invention relates to kitchen appliances, specifically relating to heating water to a desired temperature.

### BACKGROUND OF THE INVENTION

Kettles are common appliances used in almost every private, and restaurant kitchen for the purposes of heating water.

Water is heated often to make tea or coffee, but has a wide variety of other purposes. For example hot, or heated water is called for in various cooking recipes, as well as many instant drinks and meal packages.

Prior kettles are designed to give a signal when the water being heated in them is boiling. However, the kettle is otherwise imprecise for displaying the specific temperature of the water it is heating. Therefore prior kettles are not convenient for heating water to a desired temperature (other than boiling).

Common kettles also lack to demonstrate how much water is contained inside them. There is no convenient way to measure the volume of the liquid inside them.

Prior kettles commonly have no method for filtering impurities out of the water they heat. Their sole purpose is to boil water and indicate when the water is boiling.

Additionally, prior kettles are made for intended use on stove-tops. There are two disadvantages to stove-top heating.

One disadvantage is a potential fire hazard. A person may begin to heat a kettle, forget about it, and leave the house with the stove-top on, creating a dangerous situation.

Another disadvantage is that, because kettles require stove-tops, they can not be used in places without stoves (or stove burners). It is common for many student dormitories and office kitchens to have a microwave oven, but have no stove or stove burners.

### BACKGROUND OF INVENTION—OBJECTS AND ADVANTAGES

Accordingly, several objects and advantages of the present invention are:

(a) to provide an appliance which can be used to heat liquid in a microwave oven;

(b) to provide an appliance which contains a readable thermometer;

(c) to provide an appliance which filters impurities from the water it heats;

(d) to provide an appliance which will not cause a potentially hazardous situation;

(e) to provide an appliance which can be used in school dormitories, office kitchens and places that have a microwave oven, but no stove top.

Further objects and advantages of the present invention will become apparent from a consideration of the drawings and ensuing description.

### SUMMARY

In accordance with the present invention a micokettle comprises a container with a readable thermometer, to heat water in a microwave oven to a desired temperature. It has additional features removable water filter and a volume measure.

### DRAWINGS—FIGURES

FIG. 1 is a side elevational view of a kettle according to one embodiment of the invention.

FIG. 2 shows that the kettle has a removable lid.

FIG. 3 shows a removable filter in use.

DRAWINGS-Reference Numerals

| | |
|---|---|
| 10 kettle | 12 main body of kettle |
| 14 bottom of kettle | 15 top of kettle |
| 16 receptacle | 18 handle |
| 20 thermometer | 22 volume measure |
| 24 spout | 26 lid |
| 28 removable filter | 30 top of filter |
| 32 bottom of filter | 40 hinges on top of kettle |
| 42 thumb-rest | 50 spout opening |

### DETAILED DESCRIPTION OF THE INVENTION

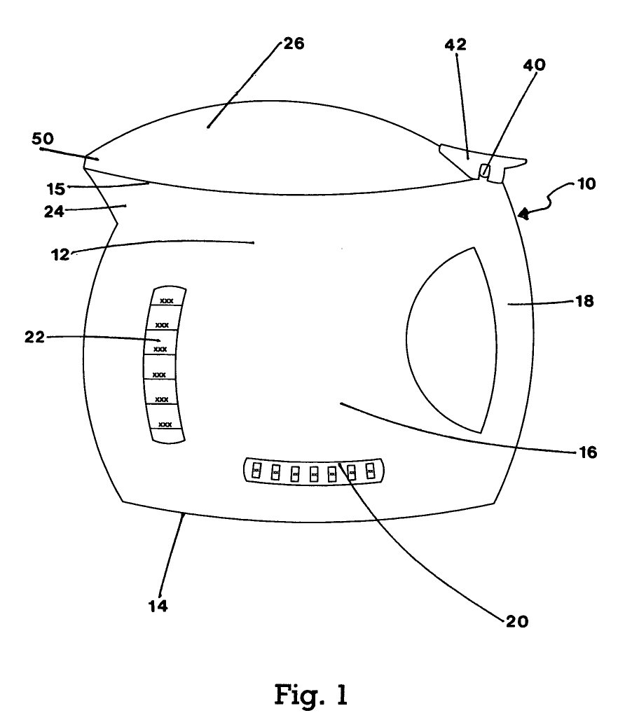

Referring to FIG. 1, a preferred embodiment of a kettle 10 is shown. The kettle 10 is approximately 18 cm tall and 23 cm wide. The kettle 10 has a main body 12, which contains a handle 18. The main body 12 has a bottom 14, a top 15, and portions that define a receptacle 16 for receiving and containing water, or other liquids. The kettle 10 also has a lid 26, a spout 24, a thermometer 20, and a volume measure 22.

A preferred embodiment of the thermometer 20 has approximate measurements of 3 cm tall and 10 cm wide. It is positioned closely towards the bottom of the kettle 14. This allows the temperature of any liquid inside of the kettle 10 to be determined, even if the volume of that liquid is minimal. The preferred embodiment of the thermometer 20 has markings of degrees of temperature that are large and colored. This allows that they are readable, even while the kettle 10 is being heated inside of a microwave oven (with a transparent door).

A preferred embodiment of the kettle 10 includes a volume measure 22. The volume measure 22 is a transparent window. It is approximately 3 cm wide, and 14 cm tall. The volume measure 22 is on the side of kettle 10, situated in a vertical position. It has opaque volume measurement markings along it, for example “100 ml, 200 ml, 300 ml” so that the volume of liquid inside of kettle 10 can be easily determined.

A preferred embodiment of the handle 18 allows it to contain some water, in order to maximize the amount of liquid that the kettle 10 can contain. It has a gripping radius and a texture that is comfortable and easy to use.

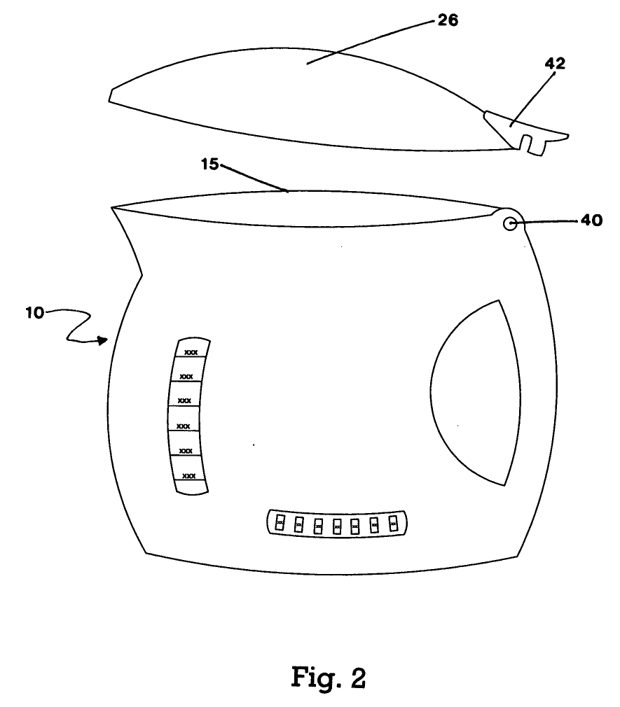

Referring to FIG. 2, a preferred embodiment of the removable lid 26 is shown. The lid 26 has a hinged thumb-rest 42 on one side and a spout opening 50 on the opposite side. The hinges on the top of the kettle 40 meet the hinged thumb-rest 42 of the lid 26 so that it can be levered, enlarging the opening of the spout 24.

Additionally, the design of the lid 26 allows the lid 26 removed entirely from the top of the kettle 15 by lifting the hinged thumb-rest off of the hinges on the top of the kettle 40.

The spout opening 50 on the opposite side of the lid 26 allows liquid to be poured out of the kettle 10 even when the lid 26 is fully on the main body of the kettle 12.

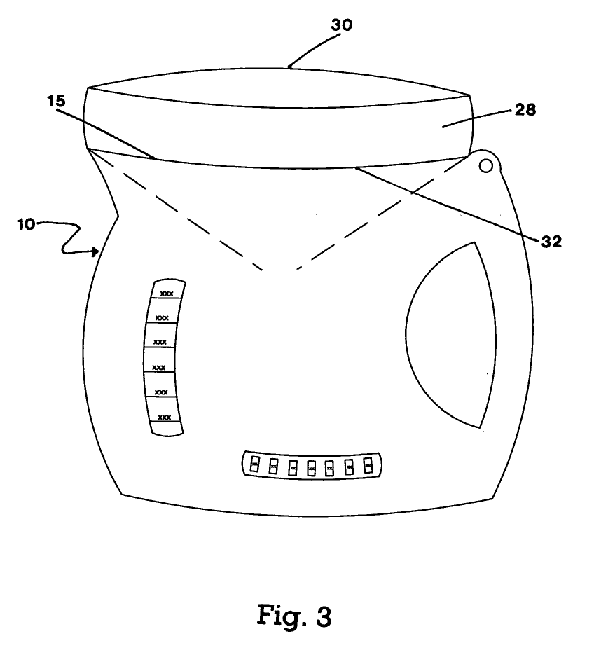

Referring to FIG. 3, a preferred embodiment of a removable filter 28 is shown. It has a top 30 and bottom 32. The top of the filter 30 is made to receive water, much like the top of a funnel. It is rounded and somewhat thick in order to guide liquid into its filtering system. The bottom of the filter 32 is made to meet directly with the top of the kettle 15.

This meeting is such that water passing through filter 28 will be routed directly through filter 28 and into the kettle 10 without any leaking between the bottom of the filter 32 and the top of the kettle 15.

### Operation

The kettle 10 is used for heating liquid, most often water, to a desired temperature.

Take the lid 26 off of the main body of the kettle 12 by lifting its hinged thumb-rest 42 off of the hinges on top of the kettle 40, and set it aside. Place the filter 28 so that it fits into the top of the kettle 15.

Fill the kettle 10 with the cold tap water, passing it through the filter 28. (Cold tap water contains fewer impurities than hot tap water.)

Use the volume measure 22 in order to achieve a desired specific amount of liquid.

Once the kettle is filled, remove the filter 28 and replace the lid 26 by re-attaching the hinged thumb-rest 42 to the hinges on the top of the kettle 40.

Next, heat the kettle 10 in a microwave oven (not shown) until the desired temperature is indicated on the thermometer 20.

Pour the liquid out of the kettle 10 by gripping the handle 18 and guiding the liquid out through the spout 24 and the spout opening 50.

The thumb-rest 42 may be used to lever the lid of the kettle 26 in order to enlarge the opening of the spout 50.

Although the description above contains many specifications, these should not be construed as limiting the scope of the invention but as merely providing illustrations of some of the presently preferred embodiments of this invention. For example, the thermometer can have a colored display with every degree marked or it can consist of a digital representation of the degree reading, and the thermometer may even contain an audio sensor that makes a noise when the liquid is boiling; the handle can be built as part of the main body of the container, containing liquid when the kettle is filled, or it can be an attachment outside of the container; the lid can have hinges as discussed, or it can be made to simply rest on the top of the main body of the kettle without hinges, etc.

Thus the scope of the invention should be determined by the appended claims and their legal equivalents, rather than by the examples given.

I claim:

1. A kitchen appliance comprising:
a. means for heating liquid in a microwave oven,
b. means for reading and displaying the temperature of said liquid,
whereby said liquid can be heated in said microwave oven to a desired temperature.

2. The appliance of claim 1 further including means, being removable, for filtering said liquid when filling said appliance with said liquid,
whereby said liquid will be filtered when filling said appliance.

3. The appliance of claim 1 further including means to determine how much of said liquid is inside of said appliance,
whereby the amount of said liquid will be directly readable to the user of said appliance.

4. The appliance of claim 1 wherein the temperature of the outside of said appliance, and especially the handle of said appliance, is low enough to be safe to the touch, despite the temperature of said liquid inside of said appliance,
whereby said appliance may be handled while containing hot or boiling liquid.

5. The appliance of claim 1 wherein the materials of said container would be useable in a refrigerator,
whereby said appliance may be used in the refrigerator.

6. The appliance of claim 1 further including a lid, being hinged and removable,
whereby the steam arising from heating said liquid will be contained in said appliance.

7. The appliance of claim 1 further including a pour spout,
whereby water will be directed when pouring from said appliance.

8. A method of heating liquid to a desired temperature comprising the step of:
(a) heating said liquid in a kettle, being microwavable.

9. The kettle of claim 8 further containing means to determine the temperature of the liquid inside of said container.

10. The kettle of claim 8 further containing a handle having means to protect the user from the heat of the liquid inside of said container.

11. The kettle of claim 8 further containing means to determine the volume of the liquid inside of said container.

12. The kettle of claim 8 further containing a lid, being hinged and removable,
whereby the heat inside of said container is mostly contained by said lid when it is in place.

13. The kettle of claim 8 further containing a means to filter impurities from liquid, being removable,
whereby using the filter when filling the kettle will provide said liquid, being more pure.

14. The kettle of claim 8 further containing a spout having a closure,
whereby liquid inside said kettle will flow out of said spout in a defined stream.
